(19) United States
(12) Patent Application Publication
(10) Pub. No.: US 2021/0262260 A1
(43) Pub. Date: Aug. 26, 2021

(54) FURNITURE HINGE

(71) Applicant: Julius Blum GmbH, Hoechst (AT)

(72) Inventor: Stefan DUER, Schwarzach (AT)

(21) Appl. No.: 17/317,440

(22) Filed: May 11, 2021

Related U.S. Application Data
(63) Continuation of application No. PCT/AT2019/060368, filed on Nov. 5, 2019.

(30) Foreign Application Priority Data
Nov. 13, 2018 (AT) A 50978/2018

(51) Int. Cl. E05D 11/00; E05D 15/26

(52) U.S. Cl. CPC E05D 11/0054; E05Y 2900/212; E05D 2011/0072; E05D 15/264

(57) ABSTRACT

A furniture hinge includes a first fitting portion, a second fitting portion, and a hinge axis hingedly connecting the first fitting portion and the second fitting portion. The fitting portions are movable between a first position, in which the furniture parts are aligned substantially coplanar to one another, and a second position, in which the furniture parts are aligned substantially parallel to one another. A cover can at least partially cover a gap formed between the first fitting portion and the second fitting portion, and a movement of the cover can be coupled to a movement of the furniture hinge. The first fitting portion and/or the second fitting portion includes an abutment, and the cover includes a counter-abutment. Upon a relative movement of the fitting portions, the abutment abuts against the counter-abutment. The cover, due to the abutment bearing against the counter-abutment, can be moved about the hinge axis.

### BACKGROUND OF THE INVENTION

The present invention relates to a furniture hinge including a first fitting portion configured to be fixed to a first furniture part, a second fitting portion configured to be fixed to a second furniture part, and at least one hinge axis by which the first fitting portion and the second fitting portion are hingedly connected to one another. The fitting portions are movable relative to one another between a first position, in which the furniture parts connected to the fitting portions in a mounted condition are aligned substantially coplanar to one another, and a second position, in which the furniture parts connected to the fitting portions in the mounted condition are aligned substantially parallel to one another. A cover is movably supported about the hinge axis, the cover is configured to at least partially cover a gap formed between the first fitting portion and the second fitting portion, and a movement of the cover can be coupled to a movement of the furniture hinge.

Moreover, the invention concerns an item of furniture comprising at least two furniture parts movable relative to a furniture carcass and at least one furniture hinge of the type to be described for moving the furniture parts.

Furniture hinges with a cover configured to be moved relative to the fitting portions upon a movement of the furniture hinge are already known from EP 2 899 344 A1 and WO 99/23337 A1. The cover is configured to cover a gap formed between the furniture parts, so that an engagement of fingers into the gap can be prevented, the ingress of dirt into the interior of the item of furniture can be reduced and a visually attractive appearance can be afforded. A movement of the cover is thereby always coupled to a movement of the hinge. Because of the fact that the size of the gap formed between the furniture parts varies upon the relative position of the furniture parts to one another, certain motion sequences of the furniture hinge cannot be realized due to the presence of a permanently-coupled cover. The kinematics of the furniture hinge is namely then obstructed when the cover abuts against the furniture parts or against a hinge mechanism of the furniture hinge in a relative position of the furniture hinge and, therefore, a further movement of the furniture hinge is blocked.

GB 2 456 144 A discloses a furniture hinge having a finger guard, and the finger guard includes a cover configured to pivot about a hinge axis. The cover is moved about the hinge axis by abutment surfaces of the fitting portions, so that a hinge gap which is formed between the fitting portions can be covered and an engagement of fingers in that gap can be prevented. A drawback is the fact that the construction is only suitable for applications in which the maximum opening angle of the door is limited to approximately 110°.

### SUMMARY OF THE INVENTION

It is an object of the present invention to propose a furniture hinge of the type mentioned in the introductory part, thereby avoiding the drawbacks as discussed above.

According to the invention, the first fitting portion and/or the second fitting portion includes or include at least one abutment and that the cover includes at least one counter-abutment. The abutment of the first fitting portion and/or of the second fitting portion, upon a relative movement of the fitting portions to one another, abuts against the counter-abutment of the cover, and the cover, due to the at least one abutment bearing against the at least one counter-abutment, is configured to be moved at least partially about the hinge axis.

In other words, the cover is freely pivotable on the furniture hinge, or possibly configured to be moved about the hinge axis against a force of a force storage member. The cover is only moved about the hinge axis over a predetermined pivotal path by the co-operation of an abutment arranged on the fitting portions with a counter-abutment arranged on the cover. The fitting portions of the furniture hinge are pivotally supported to one another over a predetermined angle range. The cover is not moved over a first partial path of the angle range, and is only moved over a second partial path immediately adjoining the first partial path of the angle range, due to the co-operation of the abutment with the counter-abutment, into a predetermined end position of the fitting portions or into a predetermined end position of the furniture parts connected to the fitting portions in a mounted condition.

In this way, the cover can be automatically centered upon each closing movement and/or opening movement, so that the cover is optimally aligned in the respective end positions of the furniture parts connected to the fitting portions.

Basically, the presence of one single abutment of the fitting portions and the presence of one single counter-abutment of the cover can be sufficient for moving the cover into a first pivoting direction. For a movement of the cover in a second pivoting direction opposing the first pivoting direction, the cover may have a second counter-abutment configured to abut against a second abutment of the first fitting portion and/or the second fitting portion upon a relative movement of the fitting portions to one another. Therefore, the cover is configured to be moved at least partially about the hinge axis due to the second abutment bearing against the second counter-abutment.

However, the arrangement of a second abutment of the fitting portions and/or the arrangement of a second counter-abutment on the cover is not mandatorily required. With an alternative embodiment, it can namely be provided that the cover can be moved in a first pivoting direction due to the at least one abutment of the fitting portions bearing against the at least one counter-abutment of the cover, against a force of a force storage member (for example a spiral spring), so that the force storage member can be loaded.

The cover can then be driven in a second pivoting direction, opposing the first pivoting direction, by a force of the force storage member.

The cover can have a longitudinal extension, and it is preferably provided that a shell surface of the cover, in a cross-section perpendicular to the longitudinal extension, is configured to be curved-shaped. According to an embodiment, the shell surface of the cover can be configured so as to be partially cylindrical. It is preferable that the shell surface of the cover extends over more than a semi-cylinder.

The furniture hinge can include at least one hinge body pivotally supported about the hinge axis, and the cover is connected to the hinge body or is configured to be releasably connected to the hinge body. It can be preferably provided that the cover is configured to be snapped onto the at least one hinge body. The hinge body can thereby be configured to be freely pivotable about the hinge axis, or may be movably arranged about the hinge axis against a force of a force storage member.

The hinge body can be pivotally and coaxially arranged to the at least one hinge axis. It can be preferably provided that the at least one hinge body is configured substantially cylindrical. The hinge body can have a ribbing at least over a region, and the ribbing is provided for releasably fixing the cover.

According to an embodiment, it can be provided that at least two hinge bodies are provided, the at least two hinge bodies being spaced from each other along the hinge axis.

According to a further embodiment, the counter-abutment of the cover can extend substantially parallel to a longitudinal axis of the cover. It can be preferably provided that the counter-abutment extends substantially over an entire length of the cover. The counter-abutment of the cover can be configured, for example, as a rounded limb extending at least over a region in the longitudinal direction of the cover.

According to the invention, the fitting portions of the furniture hinge are movable relative to one another between a first position, in which the furniture parts connected to the fitting portions in a mounted condition are aligned substantially coplanar to one another, and a second position, in which the furniture parts connected to the fitting portions in the mounted condition are aligned substantially parallel to one another.

### BRIEF DESCRIPTION OF THE DRAWINGS

Further details and advantages of the invention result from the following description of figures, in which:

FIG. 1a, 1b are perspective views of an item of furniture comprising a furniture carcass and furniture parts movably-supported relative to the furniture carcass in two different positions,

FIG. 2 shows a possible embodiment of a furniture hinge in a perspective view,

FIG. 3 shows the furniture hinge according to FIG. 2 in a further relative position of the fitting portions to one another,

FIG. 4 shows the furniture hinge in an exploded view,

FIG. 5a-5d show the furniture hinge in two different relative positions of the fitting portions to one another in a view from below, and enlarged detail views thereof, and

FIG. 6a-6d show the furniture hinge in two further relative positions of the fitting portions to one another in a view from below, and enlarged detail views thereof.

### DETAILED DESCRIPTION OF THE INVENTION

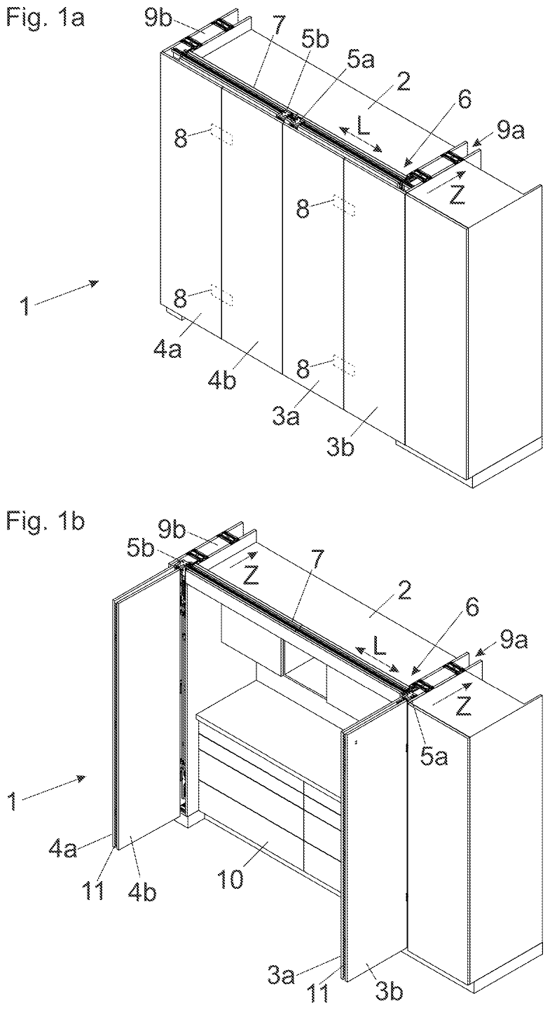

FIG. 1a shows an item of furniture 1 comprising a furniture carcass 2 and furniture parts 3a, 3b and 4a, 4b, each of the furniture parts 3a, 3b and 4a, 4b being movably supported relative to the furniture carcass 2. The furniture parts 3a, 3b are hingedly connected to one another by two or more furniture hinges 8, the furniture hinges 8 being spaced from each other in a height direction and being fixed to a rear side of the furniture parts 3a, 3b. The other two furniture parts 4a, 4b are also pivotally connected to one another by two or more furniture hinges 8 spaced from one another in the height direction. In the shown figure, the furniture parts 3a, 3b and 4a, 4b are located in a first position in which the furniture parts 3a, 3b and 4a, 4b are aligned substantially coplanar to one another. The furniture parts 3a, 3b and 4a, 4b are movable relative to the furniture carcass 2 by a guide system 6, the guide system 6 including a guide rail 7 and running carriages 5a, 5b movably supported in a longitudinal direction (L) of the guide rail 7. The guide rail 7, in a mounted condition, is arranged substantially parallel to a front edge of the furniture carcass 2. The first running carriage 5a is hingedly connected to the furniture part 3a, whereas the second running carriage 5b is pivotally connected to the furniture part 4b.

FIG. 1b shows the item of furniture 1 according to FIG. 1a, in which the furniture parts 3a, 3b and 4a, 4b are located in a second position in which the furniture parts 3a, 3b and 4a, 4b are aligned substantially parallel to one another. The furniture parts 3a, 3b, in a parallel position to one another, can be inserted—jointly with the first running carriage 5a—into a first lateral insertion compartment 9a in a depth direction (Z). The other furniture parts 4a, 4b, in a parallel position to one another, can be inserted—together with the second running carriage 5b—into a second lateral insertion compartment 9b in the depth direction (Z). A gap is formed between each of the furniture parts 3a, 3b and 4a, 4b, and the gap can be at least partially covered by a cover 11 in at least one relative position of the furniture hinges 8. In the parallel positions of the furniture parts 3a, 3b and 4a, 4b, the covers 11 are arranged between the furniture parts 3a, 3b and 4a, 4b. The covers 11 are formed as longitudinal profiles made of metal or plastic, the covers 11 extending substantially over an entire height of the furniture parts 3a, 3b and 4a, 4b. A direct comparison between FIG. 1a and FIG. 1b shows that in a first position, in which the furniture parts 3a, 3b and 4a, 4b are aligned substantially coplanar to one another (FIG. 1a), an inner carcass 10 can be entirely separated from the remaining area of a room. In the second position, in which the furniture parts 3a, 3b and 4a, 4b are aligned substantially parallel to one another, the inner carcass 10 is freely accessible for a person. For example, the inner carcass 10 can be in the form of a kitchen block, an office niche, a storage room, a shelf or a walk-in closet.

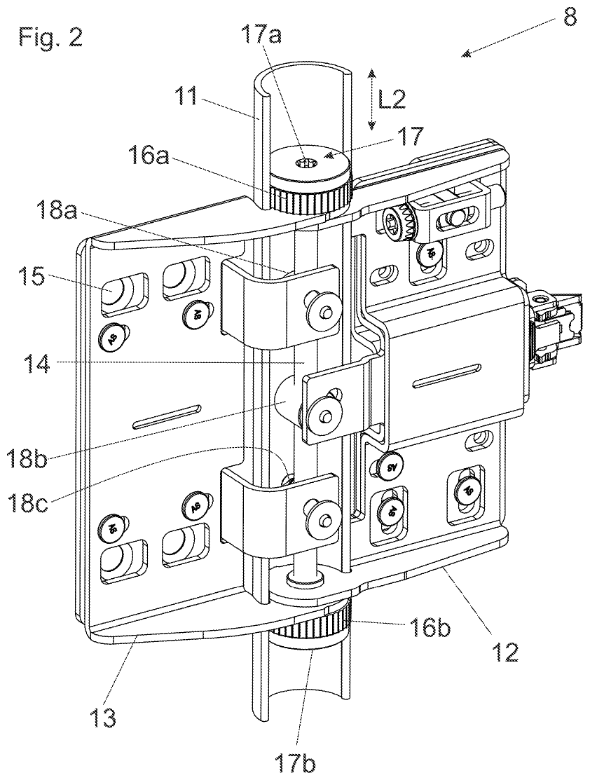

FIG. 2 shows a possible embodiment of a furniture hinge 8 in a perspective view. The furniture hinge 8 includes a first fitting portion 12 configured to be fixed to a first furniture part 3a and a second fitting portion 13 configured to be fixed to a second furniture part 3b. The first fitting portion 12 and the second fitting portion 13 are pivotally connected to one another by at least one hinge axis 14. Each of the fitting portions 12, 13 can include a flat-shaped bearing surface configured to be fixed to a flat-shaped inner side of the furniture parts 3a, 3b. The first fitting portion 12 and/or the second fitting portion 13 can include at least one or a plurality of fastening locations 15, for example in the form of bores. By the fastening locations 15, the fitting portions 12, 13 can be fixed to the furniture parts 12, 13, for example with the aid of screws. In FIG. 2, the fitting portions 12, 13 are located in a position corresponding to the coplanar first position of the furniture parts 3a, 3b to one another (FIG. 1a).

The cover 11 has a longitudinal direction (L2), and a shell surface of the cover 11, in a cross-section perpendicular to the longitudinal direction (L2), can be curved-shaped.

According to a possible embodiment, the shell surface of the cover 11 can be partially cylindrical. It can be preferably provided that the shell surface of the cover 11 extends over more than a semi-cylinder. The cover 11 is connected or is configured to be releasably connected to the furniture hinge 8. In the shown embodiment, the cover 11 is configured to be releasably connected to at least one hinge body 16a. It can be preferably provided that the cover 11 is configured to be releasably connected to the hinge body 16a by a snap-connection device. The hinge body 16a is freely pivotally supported about the hinge axis 14, or is possibly movable about the hinge axis 14 against an action of a force storage member. The at least one hinge body 16a can be arranged coaxially to the hinge axis 14. It can be preferably provided that the at least one hinge body 16a is substantially cylindrical. In the shown embodiment, two identically configured hinge bodies 16a, 16b are provided, the hinge bodies 16a, 16b being spaced from one another along the hinge axis 14.

The furniture hinge 8 includes at least one adjustment device 17 having at least one movably supported adjustment element 17a. By an actuation of the at least one adjustment element 17a, a position of the first fitting portion 12 relative to the second fitting portion 13 can be adjusted. With a possible embodiment, it can be provided that by an actuation of the at least one adjustment element 17a, the position of the first fitting portion 12 and the position of the second fitting portion 13 can be synchronically and symmetrically adjusted in relation to the at least one hinge axis 14, preferably in a direction perpendicular to the hinge axis 14. For example, this can be implemented such that the hinge axis 14 is configured as a threaded spindle at least over a region, and the threaded spindle is in threading engagement with two or more threaded nuts 18a, 18b, 18c. The threaded nut 18b is connected to the first fitting portion 12, whereas the other threaded nuts 18a, 18c are connected to the second fitting portion 13. Upon a rotation of the adjustment element 17a, the threaded nuts 18a, 18b, 18c are adjustable along the hinge axis 14. Therefore, the fitting portions 12, 13 can be synchronically and symmetrically adjusted in relation to the hinge axis 14. The adjustment element 17a can have a receiving device for a tool, so that the adjustment element 17a can be rotated with the aid of a tool. Upon a rotation of the adjustment element 17a, the hinge bodies 16a, 16b cannot be rotated, because the hinge bodies 16a, 16b are loosely supported about the hinge axis 14. In the shown figure, two adjustment elements 17a, 17b are provided, and the two adjustment elements 17a, 17b are spaced from one another along the hinge axis 14. In this way, the adjustment elements 17a, 17b can be actuated from above and from below, preferably with the aid of a tool in the form of a screwdriver, in order for a position of the fitting portions 12, 13 to be adjusted relative to one another.

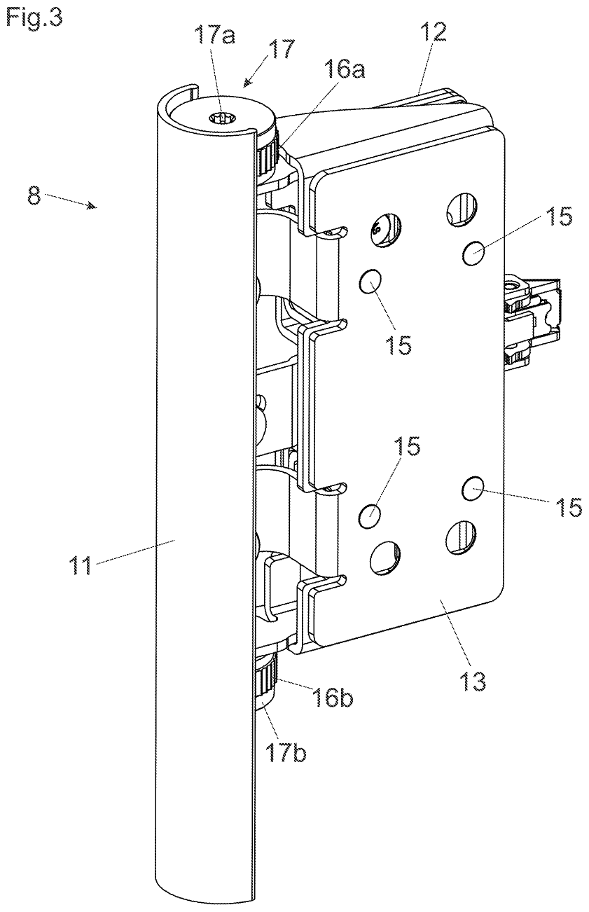

FIG. 3 shows the furniture hinge 8 in a perspective view, in which the fitting portions 12, 13 are located in a position corresponding to the parallel second position of the furniture parts 3a, 3b to one another (FIG. 1b). The cover 11 is thereby located in a centered position in relation to the fitting portions 12, 13, so that the cover 11 at least partially covers a gap formed between the furniture parts 3a, 3b when the furniture parts 3a, 3b are aligned parallel to one another. Thereby, it can be provided that the cover 11, in the parallel position of the furniture parts 3a, 3b to one another, is arranged between the furniture parts 3a, 3b, whereby an unobtrusive and compact arrangement of the cover 11 can be afforded.

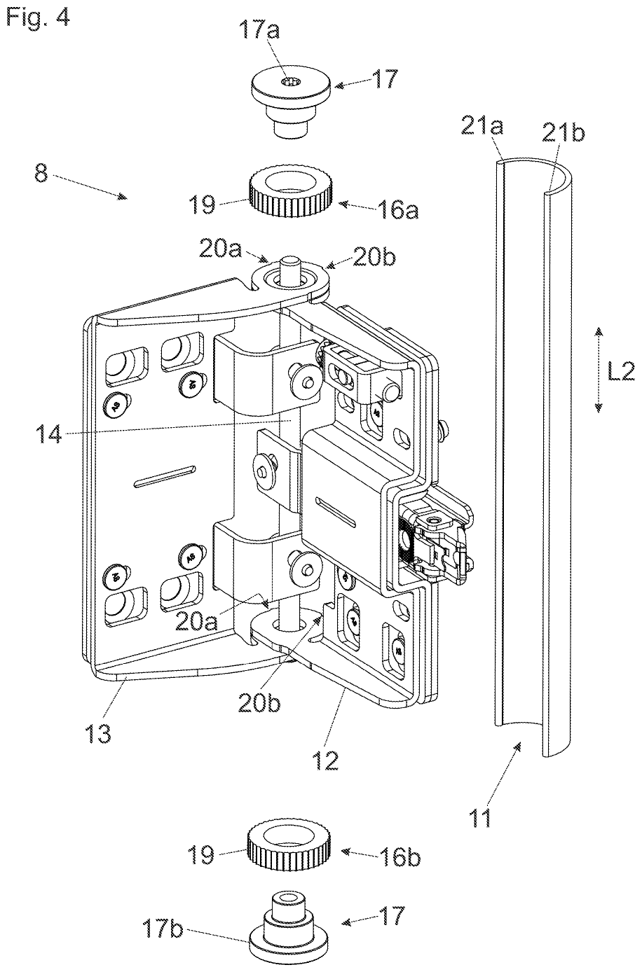

FIG. 4 shows the furniture hinge 8 in an exploded view. The first fitting portion 12 and the second fitting portion 13 are pivotally connected to one another by at least one hinge axis 14. The hinge axis 14 can be rotated by the adjustment elements 17a, 17b of the adjustment device 17 for adjusting a relative position between the first fitting portion 12 and the second fitting portion 13. A peripheral surface of the substantially cylindrical hinge bodies 16a, 16b can be provided with a ribbing 19 for releasably fixing the cover 11 to the annular-shaped hinge bodies 16a, 16b. At least one abutment 20a, 20b, preferably in the form of a control edge integrally formed on one of the fitting portions 12, 13, is arranged on the first fitting portion 12 and/or on the second fitting portion 13. At least one counter-abutment 21a, 21b is arranged or formed on the cover 11, the at least one counter-abutment 21a, 21b extending substantially parallel to a longitudinal direction (L2) of the cover 11. Preferably, the counter-abutment 21a, 21b extends over substantially an entire length of the cover 11. In the shown figure, the counter-abutment 21a, 21b of the cover 11 is configured as a rounded limb extending at least over a region along the longitudinal direction (L2) of the cover 11. Upon a movement of the fitting portions 12, 13, starting from the position shown in FIG. 4 into a position according to FIG. 3, in which the furniture parts 3a, 3b connected to the fitting portions 12, 13 in the mounted condition are aligned substantially parallel to one another, the abutment 20a of the fitting portions 12, 13 abuts against the counter-abutment 21a of the cover 11. Therefore, the cover 11 can be entrained in a pivoting direction about the hinge axis 14 due to the co-operation of the abutment 20a with the counter-abutment 21a, so that the cover 11 eventually reaches the pivoting position shown in FIG. 3.

In the shown embodiment, the cover 11 includes a second counter-abutment 21b configured to be identical as the first counter-abutment 21a. A second abutment 20b can be arranged on the first fitting portion 12 and/or on the second fitting portion 13, the second abutment 20b being configured to co-operate with the second counter-abutment 21b of the cover 11. Upon a movement of the fitting portions 12, 13, starting from the position shown in FIG. 3 in which the furniture parts 3a, 3b connected to the fitting portions 12, 13 in the mounted condition are aligned substantially parallel to one another, into the position shown in FIG. 2, in which the furniture parts 3a, 3b are aligned substantially coplanar to one another, the second abutment 20b of the fitting portions 12, 13 abuts against the second counter-abutment 21b of the cover 11. Therefore, the cover 11 can be entrained in a second pivoting direction about the hinge axis 14 due to the co-operation of the second abutment 20b with the second counter-abutment 21b, so that the cover 11 eventually reaches the pivoting position shown in FIG. 2.

As already mentioned in the introductory part, the arrangement of a second abutment 20b of the fitting portions 12, 13 and the arrangement of a second counter-abutment 21b of the cover 11 is not mandatorily required, because the cover 11 can be moved in a first pivoting direction, due to the co-operation of the first abutment 20a with the first counter-abutment 21a, against a force of a force storage member. Therefore, the cover 11 can be driven at least partially about the hinge axis 14 in a second pivoting direction by a force of the force storage member. However, the arrangement of two counter-abutments 21a, 21b on the cover 11 offers the opportunity to snap the cover 11 onto the ribbings 19 of the hinge bodies 16a, 16b via the two counter-abutments 21a, 21b. In a fixed condition, the cover 11 is held with a sufficient holding force on the hinge bodies 16a, 16b by a material elasticity of the cover 11.

Due to the co-operation of the first abutment 20a of the fitting portions 12, 13 with the first counter-abutment 21a of the cover 11, and due to the co-operation of the second abutment 20b of the fitting portions 12, 13 with the second counter-abutment 21b of the cover 11, the cover 11 can be newly centered upon each opening and closing movement. According to an embodiment, it can be provided that the at least one abutment 20a, 20b, jointly with one of the fitting portions 12, 13, has an integral one-piece configuration, and/or that the at least one counter-abutment 21a, 21b, jointly with the cover 11, has an integral one-piece configuration.

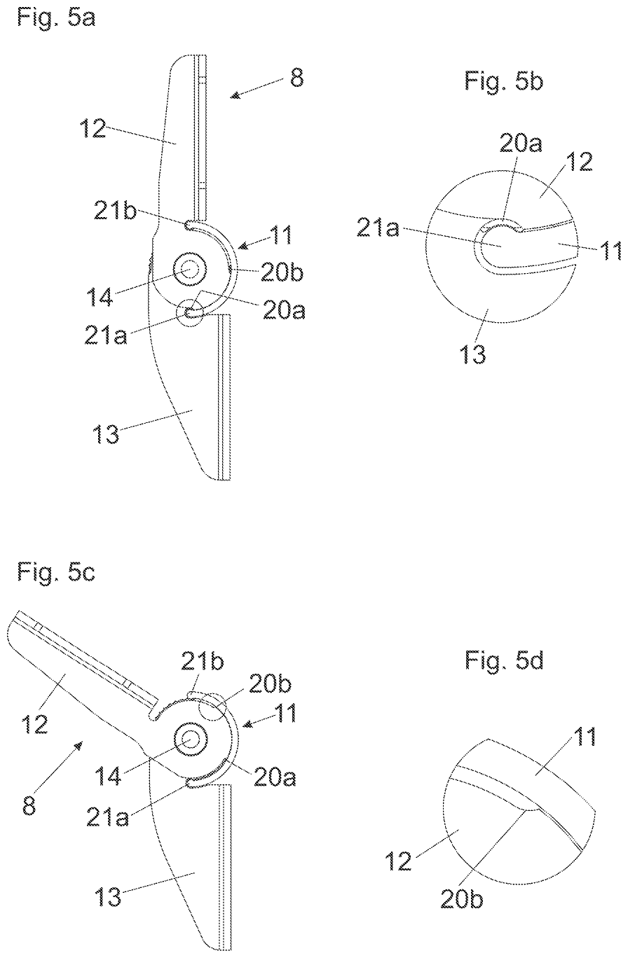

FIG. 5a shows the furniture hinge 8 in a view from below, in which the furniture parts 3a, 3b connected to the fitting portions 12, 13 in a mounted condition are aligned substantially coplanar to one another. Visible is the cover 11 with the two counter-abutments 21a, 21b. In the shown figure, the abutment 20a of the fitting portions 12, 13 bears against the counter-abutment 21a of the cover 11. FIG. 5b shows the encircled region of FIG. 5a in an enlarged view.

When now the fitting portions 12, 13 are moved relative to one another, the abutment 20a of the fitting portions 12, 13 is lifted from the counter-abutment 21a of the cover 11 (FIG. 5c), and the cover 11 remains in its relative position, that is to say that the cover 11 is not yet rotated about the hinge axis 14. In this intermediate position of the fitting portions 12, 13, the abutments 20a, 20b of the fitting portions 12, 13 are spaced from the counter-abutments 21a, 21b of the cover 11. FIG. 5d shows the encircled region of FIG. 5c in an enlarged view. It can be seen that the abutments 20a, 20b can be arranged offset relative to one another by approximately 90° on at least one of the fitting portions 12, 13.

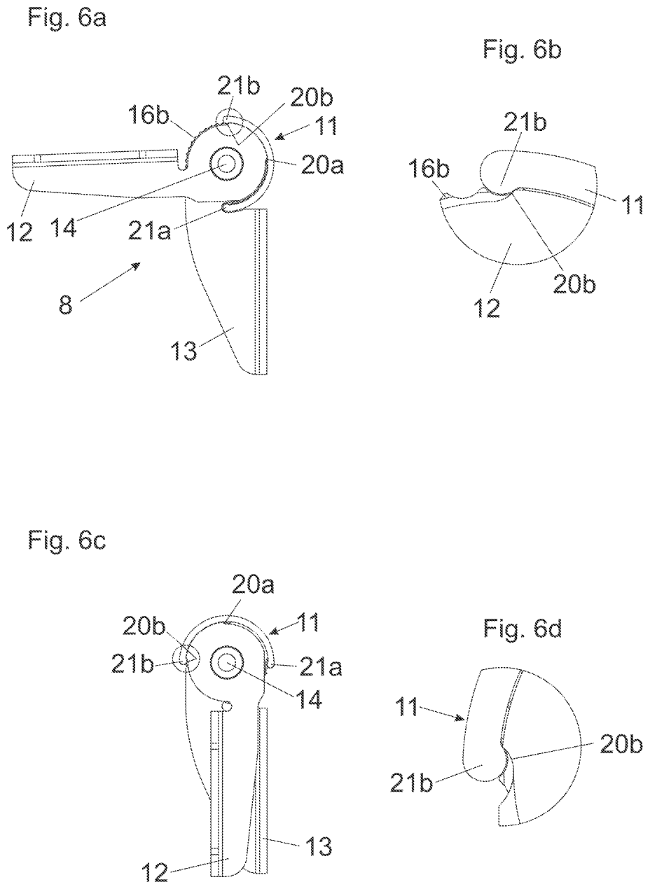

FIG. 6a shows the furniture hinge 8 in a view from below in a further relative position of the fitting portions 12, 13 to one another, in which the furniture parts 3a, 3b connected to the fitting portions 12, 13 in a mounted condition adopt an angle of approximately 90° to one another. It can be seen that the abutment 20b of the fitting portions 12, 13 abuts against the counter-abutment 21b of the cover 11, thereby initiating the start of a pivoting movement of the cover 11 about the hinge axis 14. FIG. 6b shows the encircled region of FIG. 6a in an enlarged view.

By a continued movement of the fitting portions 12, 13 to one another, the cover 11 is pivoted in an anticlockwise direction due to the co-operation of the abutment 20b with the counter-abutment 21b. In FIG. 6c, the fitting portions 12, 13 have reached a position in which the furniture parts 3a, 3b connected to the fitting portions 12, 13 in a mounted condition are aligned substantially parallel to one another (FIG. 1b). The cover 11 has been moved by the abutment 20b of the fitting portions 12, 13, starting from FIG. 6a, over a partial path of the maximum pivoting angle range of the furniture hinge 8 about the hinge axis 14, and the cover 11 is centered relative to the fitting portions 12, 13.

1. A furniture hinge, comprising:
a first fitting portion configured to be fixed to a first furniture part,
a second fitting portion configured to be fixed to a second furniture part,
at least one hinge axis by which the first fitting portion and the second fitting portion are hingedly connected to one another,
wherein the fitting portions are movable relative to one another between a first position, in which the furniture parts connected to the fitting portions in a mounted condition are aligned substantially coplanar to one another, and a second position, in which the furniture parts connected to the fitting portions in the mounted condition are aligned substantially parallel to one another,
a cover movably supported about the hinge axis, the cover being configured to at least partially cover a gap formed between the first fitting portion and the second fitting portion, and a movement of the cover can be coupled to a movement of the furniture hinge,
wherein the first fitting portion and/or the second fitting portion includes or include at least one abutment and that the cover includes at least one counter-abutment, wherein the abutment of the first fitting portion and/or of the second fitting portion, upon a relative movement of the fitting portions to one another, abuts against the counter-abutment of the cover, and the cover, due to the at least one abutment bearing against the at least one counter-abutment, is configured to be moved at least partially about the hinge axis.

2. The furniture hinge according to claim 1, wherein the cover has a longitudinal direction, wherein it is preferably provided that a shell surface of the cover, in a cross-section perpendicular to the longitudinal direction, is configured so as to be curved-shaped.

3. The furniture hinge according to claim 1, wherein a shell surface of the cover is partially cylindrical, wherein it is preferably provided that the shell surface of the cover extends over more than a semi-cylinder.

4. The furniture hinge according to claim 1, wherein the furniture hinge includes at least one hinge body pivotally supported about the hinge axis, wherein the cover is connected or is configured to be releasably connected to the at least one hinge body.

5. The furniture hinge according to claim 4, wherein the at least one hinge body is coaxially arranged to the at least one hinge axis, wherein it is preferably provided that the at least one hinge body is configured substantially cylindrical.

6. The furniture hinge according to claim 4, wherein the at least one hinge body, at least over a region, has a ribbing for releasably fixing the cover.

7. The furniture hinge according to claim 4, wherein at least two hinge bodies are provided, the at least two hinge bodies being spaced from one another along the hinge axis.

8. The furniture hinge according to claim 1, wherein the at least one counter-abutment of the cover extends substantially parallel to a longitudinal direction of the cover, wherein it is preferably provided that the counter-abutment extends substantially over an entire length of the cover.

9. The furniture hinge according to claim 1, wherein the at least one counter-abutment of the cover is configured as a rounded limb.

10. The furniture hinge according to claim 1, wherein the at least one counter-abutment of the cover, in the first position or in the second position, bears against the at least one abutment of one of the fitting portions.

11. The furniture hinge according to claim 1, wherein the at least one counter-abutment of the cover, in at least one intermediate position located between the first position and the second position of the furniture hinge, is spaced from the at least one abutment of one of the fitting portions.

12. The furniture hinge according to claim 1, wherein the at least one abutment, jointly with one of the fitting portions, has an integral one-piece configuration, and/or that the at least one counter-abutment, jointly with the cover, has an integral one-piece configuration.

13. The furniture hinge according to claim 1, wherein the cover is movable about the hinge axis in a first pivoting direction due to the co-operation of the abutment with the counter-abutment, wherein it is preferably provided that the first fitting portion and/or the second fitting portion includes or include at least one second abutment and that the cover includes at least one second counter-abutment, wherein the cover is movable about the hinge axis in a second pivoting direction opposing the first pivoting direction due to the co-operation of the second abutment with the second counter-abutment.

14. An item of furniture comprising a furniture carcass, a first furniture part and at least one second furniture part, each of the first furniture part and the second furniture part being movably supported relative to the furniture carcass and being hingedly connected to one another by the furniture hinge according to claim 1.
